(19) United States
(12) Patent Application Publication
(10) Pub. No.: US 2012/0028214 A1
(43) Pub. Date: Feb. 2, 2012

(54) ACCESSORY FOR THE PRODUCTION OF DENTURES

(75) Inventors: Norbert FUTTERKNECHT, Minusio (CH); Vanik KAUFMANN-JINOIAN, Stein (CH)

(73) Assignee: Vanotech Sagl, Minusio (CH)

(21) Appl. No.: 13/193,068

(22) Filed: Jul. 28, 2011

(30) Foreign Application Priority Data
Jul. 29, 2010 (CH) 1247/10
Jan. 26, 2011 (DE) 202011001969.1

(51) Int. Cl. A61C 13/36

(52) U.S. Cl. 433/74; 433/213

(57) ABSTRACT

An accessory (100) for the production of dental implant-carried dentures in the dental technician's laboratory has an essentially smooth outer face and a connection geometry (115), corresponding to a dental implant, for dentures. The outer face has, further, a conical portion (120). The conical portion (120) allows an axially and radially accurately defined insertion of the accessory (100) into a corresponding receptacle of the jaw model which is used for producing the dentures, that is to say the accessory (100) can basically be removed from the model and inserted into the latter again so as to fit. Although the outer form of the accessory therefore usually does not correspond to that of the simulated implant, the accessory has, particularly at its proximal end and with respect to its inner contour, the connection geometry (115), corresponding to the dental implant, for the dentures, so that these can be manufactured so as to fit. As a result of the individual accessories (and, if appropriate, the dentures attached to them) being removable, the production of a sawn model may be dispensed with, with the result that costs can be saved and the accuracy of the model increased.

### TECHNICAL FIELD

The invention relates to an accessory for the production of dental implant-carried dentures in the dental technician's laboratory, the accessory having an essentially smooth outer face and a connection geometry, corresponding to a dental implant, for dentures.

### PRIOR ART

In the production of dental implant-carried dentures (superstructures, such as crowns, bridges or prostheses), a model of the affected jaw or jaw region is usually made first, for example from hard gypsum. At least in more complex work, the model is provided as a sawn model, that is to say the model is sawn up, and in this case the individual parts can be joined to one another later again so as to fit together, as required, for example in that they can be placed onto the model base at the corresponding locations.

The dental implants at their proximal end, that is to say the end facing the superstructure to be attached, have defined connection geometries (different, depending on the manufacturer) which make it possible to attach the superstructure firmly (directly or via implant posts). As a rule, the connection geometries comprise, inter alia, internal threads.

So that the superstructure can be produced with the aid of the model, conventionally model implants or steel dowels (retentions) are cast into the model, are firmly anchored in the model, occupy the space for the implant and make available a connection geometry which corresponds to that of the implant (or, if appropriate, directly to the implant posts). By the sawn model being produced, the retentions embedded in the gypsum model can be used individually for producing the corresponding superstructure.

The use of a sawn model entails sources of error, such as inaccuracies caused by the attachment of the individual parts to the model base. Moreover, the production of a sawn model is complicated and costly.

### PRESENTATION OF INVENTION

The object of the invention is to provide an accessory which belongs to the technical field mentioned in the introduction and which makes it possible to produce dental implant-carried dentures accurately and simply.

The solution for achieving the object is defined by the features of claim 1. According to the invention, the accessory has a retention boss which is arranged distally on the accessory, an undercut region being formed between a base portion of the accessory and the retention boss.

The accessory allows accurate production and simulation of dental implant-carried work in the dental technician's laboratory. The accessory can basically be removed from the model again and inserted into this again so as to fit. Even when the dental accessory is cast into the model, it can be taken out of the model again later in a simple way in the proximal direction. So that removal is possible, the outer face is designed to be essentially smooth (that is to say, has no thread or profilings). Although the outer form of the accessory therefore usually does not correspond to that of the simulated implant, the accessory has, particularly at its proximal end and with respect to its inner contour, the connection geometry, corresponding to the dental implant, for the dentures, so that these can be manufactured so as to fit.

A method according to the invention for the production of dental implant-carried dentures comprises the following steps:
a) production of a model of an affected jaw or jaw region;
b) insertion of a dental accessory into the model, a position and orientation of the accessory corresponding to a position and orientation of a dental implant to be inserted, the accessory having an essentially smooth outer face and a connection geometry, corresponding to a dental implant, for the dentures and being held in the receptacle so as to fit.

As a result of the individual accessories (and, if appropriate, the dentures attached to it) being removable, the production of a sawn model may be dispensed with, with the result that costs can be saved and the accuracy of the model increased. In particular, the check of parallelism with further implants and the analysis of contact points with adjacent teeth are improved.

The geometry of the accessory not only allows use in connection with conventional gypsum models produced by effusing an impression, but also with other models, on the one hand those made from other materials, such as epoxy, silicones, polyurethanes, synthetic resins, metals, etc., and, on the other hand, those which are produced by other methods, for example rapid prototyping methods, such as stereolithography (SLA), or CAD/CAM methods (for example, by milling). In this case, as early as during the production of the model, a receptacle, in particular an exactly fitting reception space, can be provided for the accessory, the geometry of the receptacle being adapted to the position and orientation of the dental implant to be inserted. The geometry of the accessory makes it possible, in contrast to conventional retentions, such as implant models, to carry out insertion at a later stage.

The production of the model and production of the receptacle may both be carried out by means of CAD/CAM methods. Both steps preferably take place in one operation, that is to say the receptacles are executed automatically during the production of the model.

The undercut formed proximally with respect to the retention boss gives rise, during the casting of the accessory, to a connection secured axially in both directions, so that the accessory is held firmly on the model.

Even the accessory provided with the retention boss and, for example, cast into the model can be removed again. For this purpose, before the accessory is drawn out, the retention boss is removed, for example milled away or cut off, from the accessory, starting from a distal side of the model.

Advantageously, the accessory is manufactured from an acid-resistant and oxidation-resistant metal alloy, for example from a nickel silver alloy. Although the dentures are usually manufactured shortly after the production of the model and introduction of the accessory, the models, as a rule, have to be stored for a comparatively long period of time, in order, if required, to enable forensic investigations to be carried out. A robust alloy ensures that the accessory does not degenerate during this period of time. The material is selected such that it is deformed only very insignificantly under the forces acting upon it, in particular torques acting upon it, so that accuracy is not impaired.

As an alternative to a nickel silver alloy, other materials are possible, in particular other metal alloys or metals (for example, titanium or aluminium), and also hard plastics.

The accessory may be used once only or more than once.

The outer face of the accessory preferably has a conical portion. The conical portion allows an axially and radially exactly defined insertion of the accessory into a corresponding receptacle of the model. On account of the conical form, support over a large area is obtained, not only, for example, on the end face, as in the case of a cylindrical bolt. So that removal is possible, the conical portion tapers in the distal direction.

The undercut region may directly adjoin the conical portion, or further portions may be located between the conical portion and the undercut region, for example a cylindrical portion, the cross section of which corresponds to the distal end of the conical portion.

The conical portion preferably has a cone angle of 4-10°, in particular 5-8°. This region allows reliable positioning, along with good handling, and enables the desired connection geometry to be provided at the proximal end of the accessory. Other angles are basically possible, the geometry of the accessory in each case having to be taken into account.

A conical portion, if appropriate with a cone angle in the specified range, can also be implemented with regard to an accessory which has no retention boss.

The outer face preferably comprises a cylindrical portion proximally adjoining the conical portion. This cylindrical portion may, in particular, correspond in its cross section to the cross section of the implant to be simulated, so that the conical portion merges proximally into a portion, the geometry of which corresponds to that of the implant.

The outer face advantageously has a flattening for securing the accessory against twisting. The accessory has essentially continuously a round cross section (with different diameters), but in one region this cross section is flattened. Either the accessory is cast in the model, so that a suitable receptacle is provided, or a suitable geometry is provided in the model (for example, in the case of production by rapid prototyping) before the insertion of the accessory. In both instances, the flattening on the outer face of the accessory thus cooperates with a corresponding flattening of the model and thereby prevents the accessory from being twisted about its longitudinal axis.

Even after being removed and reinserted, the accessory again has exactly the same orientation.

The flattening preferably forms a planar face which runs parallel to a longitudinal axis of the accessory, that is to say the face lies tangentially to the longitudinal axis on a circumcircle, the circumcircle having a smaller diameter than the cross section in the adjacent regions without flattening. In cross section, therefore, the region of the flattening runs along a chord.

Such a face can easily be produced and affords reliable securing against twisting in both directions of rotation. Alternatively, the flattening may have another geometry: thus, it does not have to be a planar face, but, for example, may be designed as a curved face with a different radius of curvature with respect to the surrounding regions of the accessory or may comprise a plurality of faces. The flattening may likewise run obliquely with respect to the longitudinal axis of the accessory. The geometry of the flattening may also be selected such that securing against twisting prefers one of the two directions of rotation.

The flattening is preferably formed at least partially in the conical portion. Accordingly, in the case of a suitable form and orientation of the face, for example in the case of a planar face parallel to the longitudinal axis, a step is obtained at the proximal end of the flattening. This proximal end may lie in the conical portion or in a, for example, cylindrical portion arranged proximally thereto. The step provides a bearing face for the exact axial positioning of the accessory. Together with the flattening, exact positioning of the accessory both in the axial direction and as regards orientation with respect to rotation about the longitudinal axis is obtained.

The step may also be formed differently, for example independently of the flattening, in that the cross section both behind and in front of the step is circular, but tapers abruptly in the distal direction. Accordingly, the step may be present in the conical portion, but also distally or proximally in a differently shaped portion.

The flattening, too, does not necessarily have to be formed partially in the conical portion, but may also be present, together with the step or separately from this, distally or proximally entirely in a differently shaped portion.

The step advantageously forms a planar face which runs perpendicularly with respect to a longitudinal axis of the accessory. This geometry can be produced in a simple way and ensures a reliable axial support of the accessory independently of torques acting upon the accessory. Alternatively, the step may run obliquely, so that support is further improved with regard to one of the directions of rotation.

Advantageously, an outer cross section of the accessory remains constant or decreases from a proximal end of the accessory as far as the undercut region. This enables the firstly firmly anchored accessory to be removed from the model at a later stage in that the retention boss is stripped off, for example milled away or ground away, from the distal direction, until the undercut region is reached. Since the regions adjoining it proximally widen in the direction of the proximal mouth of the receptacle for the accessory or have in regions a constant cross section, the accessory can then easily be expelled from the model in the proximal direction. It can also be positioned exactly in its receptacle again, after which merely axial securing in the proximal direction is no longer afforded. Accessories with a step to that extent afford the advantage that the accessory does not rely for accurate axial positioning upon support on the distal end of the accessory, and therefore the removal of the retention boss and of the surrounding material of the model does not influence axial positioning.

The undercut region preferably forms a parting point for the removal of the retention boss, that is to say if no axial securing in the proximal direction is required from the outset, the retention boss can be removed before the casting of the accessory, for example by being snapped off with pliers in the region of the undercut region. For this purpose, the parting point must be designed with a correspondingly small cross section. Even if the retention boss is removed only after casting, as described above, clear marking- out of the undercut region affords the advantage that it can readily be recognized when the boss has been stripped off completely.

The retention boss preferably has an essentially cylindrical form. The form may partially be flattened, as a continuation of the flattening in proximally arranged regions. This simplifies the production of the flattening, but entails no disadvantages.

In a second preferred embodiment, an outer cross section of the accessory remains constant or decreases from a proximal end of the accessory as far as a distal end of the accessory. An undercut region and consequently also a retention boss are therefore absent. Accessories according to these embodiments may be used when axial securing in the proximal direction is not desired, for example in correspondingly simpler work, or when it takes place in another way. One example is the use of the accessory according to the invention together with a model which has been produced by rapid prototyping. In this case, the accessory is preferably introduced through the proximal mouth into the specifically provided reception orifice, and axial securing on the retention boss would therefore not be possible.

As already mentioned, in the first embodiment the retention boss can be attached to the main part of the accessory via a parting point, so that, after the retention boss has been detached, essentially an accessory according to the second embodiment is obtained. The first embodiment affords the advantage that the user does not have to keep two separate assortments in stock.

In use, the accessory can be combined with a cuff designed as a sleeve which can receive the accessory with a fit, that is to say has the corresponding profilings (for example, steps, flattenings, etc.) for exact positioning and securing against twisting. The receptacle for the accessory is therefore provided by the insertion or casting of a cuff adapted to the accessory. The cuff may, for example, be cast in or be inserted into a receptacle prepared by means of a CAD/CAM method (and, if appropriate, glued in there).

The cuff is preferably designed as a tube-like body with a conical portion and is open both at its proximal and at its distal end. The accessory can project with its distal end out of the cuff and be anchored there (for example, by means of the retention boss) in the surrounding material. The use of such a cuff is possible both when conventional (hard) gypsum is employed and when models are produced by rapid prototyping. In the first instance, the cuff is cast in and is held securely in the material, for example, by means of corresponding outer profiling. In the second instance, the cuff is inserted and, for example, glued in after the model has been produced. The cuff ensures accurate positioning of the accessory and prevents damage to the surrounding model material. The cuff, like the accessory, is preferably manufactured from a metal (for example, titanium or aluminium) or a metal alloy (for example, a nickel silver alloy), so that an extremely accurate receptacle for the (preferably likewise metallic) accessory is made possible. Other materials are possible, for example hard plastics, as an alternative.

Further advantageous embodiments and feature combinations of the invention may be gathered from the following detailed description and from the patent claims as a whole.

### BRIEF DESCRIPTION OF THE DRAWINGS

In the drawings used for explaining the exemplary embodiment:

FIG. 1A shows a cross section of a first embodiment of an accessory according to the invention through a first plane perpendicular to the flattening;

FIG. 1B shows a side view of the accessory onto a second plane perpendicular to the first plane;

FIG. 1C shows an oblique view of the accessory;

FIG. 2 shows a side view of a second embodiment of an accessory according to the invention; and

FIG. 3 shows a side view of a third embodiment of an accessory according to the invention.

Identical parts are basically given the same reference symbols in the figures.

### WAYS OF IMPLEMENTING THE INVENTION

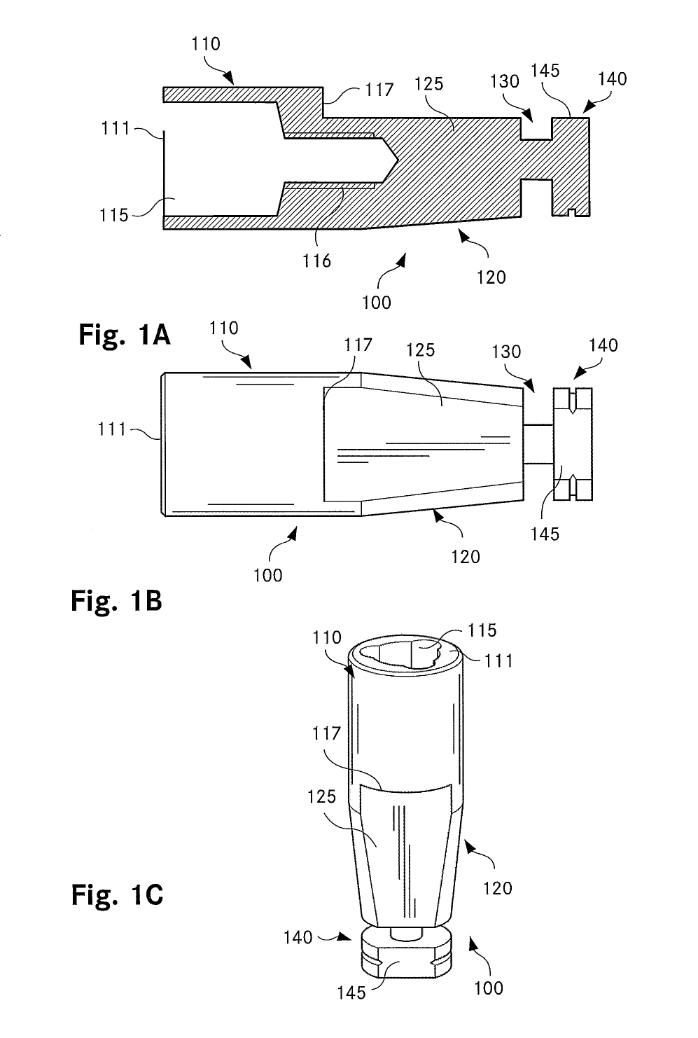

FIG. 1A shows a cross section of a first embodiment of an accessory according to the invention through a first plane perpendicular to the flattening, FIG. 1B shows a side view of the accessory onto a second plane perpendicular to the first plane, and FIG. 1C shows an oblique view of the accessory.

The accessory 100 is manufactured in one piece from a nickel silver alloy and comprises at the proximal end a cylindrical main part 110. This has adjoining it in the distal direction a conical portion 120 which adjoins, in turn, an undercut region 130 which adjoins, in turn, a cylindrical retention boss 140.

An orifice 115 running longitudinally is formed in the main part 110 and in a rear region of the conical portion 120. This orifice issues into the rear end face 111 of the main part 110 and its geometry corresponds to that of an implant to be simulated. An internal thread 116 is formed in a distal region of the orifice 115. Since the geometry may basically correspond to any known implant system, it is illustrated merely diagrammatically in the figures.

The main part 110, the undercut region 130 and the retention boss 140 are essentially circular-cylindrical, a diameter of the retention boss 140 corresponding to the diameter of the conical portion 120 at its distal end. The diameter of the main part 110 amounts to 3.5 mm in the example illustrated. The diameters of the main part 110, of the retention boss 140 and of the undercut region 130 are in a ratio of approximately 7:5:3. The length of the accessory 100 amounts to 15 mm (main part: 6.8 mm, conical portion: 8.2 mm, undercut region: 1.0 mm, retention boss: 1.5 mm). The cone angle of the conical portion 120 therefore amounts to approximately 5°.

Formed in the conical portion 120 and in the cylindrical main part 110 is a flattening 125. This forms a planar face which runs parallel to the longitudinal axis of the accessory 100. The flattening 125, at its proximal end which is arranged in the main part 110 a good quarter of the length of the main part 110 behind the transition to the conical portion 120, forms a step 117 in the form of a planar face which is oriented perpendicularly to the longitudinal axis. The flattening 125 is continued in the same plane in the retention boss 140 as the flattening 145. This makes it possible to produce the flattening 125, 145 in a simple way in that a single planar milling cut from the distal end of the accessory 100 is sufficient for this purpose.

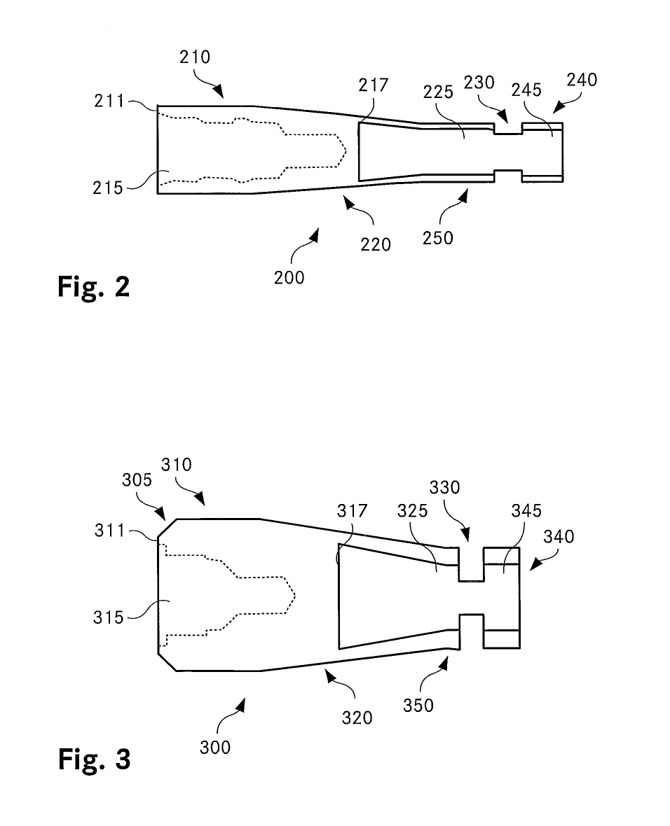

FIG. 2 shows a side view of a second embodiment of an accessory according to the invention.

The accessory 200 is manufactured in one piece from a nickel silver alloy and comprises at the proximal end a cylindrical main part 210. This has adjoining it in the distal direction a conical portion 220 which a further cylindrical portion 250 and then an undercut region 230 adjoin, a cylindrical retention boss 240 adjoining the latter in turn.

In the main part 210 and in a rear region of the conical portion 220 is formed an orifice 215 running longitudinally. This issues into the rear end face 211 of the main part 210, and its geometry corresponds to that of an implant to be simulated. Since the geometry can correspond basically to any known implant system, it is illustrated merely diagrammatically in the figure.

The main part 210, the cylindrical portion 250, the undercut region 230 and the retention boss 240 are essentially circular-cylindrical, in the cross section illustrated the conical portion 220 merging smoothly into the cylindrical portion 220, and a diameter of the retention boss 240 corresponding to the diameter of the cylindrical portion 220. The diameter of the main part 210 amounts to 3.3 mm in the example illustrated. The diameters of the main part 210, of the cylindrical portion 250 and of the retention boss 240 are in a ratio of approximately 5:3:2. The length of the accessory 200 amounts to 15 mm (main part: 3.7 mm, conical portion: 6.3 mm, cylindrical portion: 2.5 mm, undercut region: 1.0 mm, retention boss: 1.5 mm). The cone angle of the conical portion 220 therefore amounts to approximately 5°.

In the conical portion 220 and in the cylindrical portion 250 is formed a flattening 225. This forms a planar face which runs parallel to the longitudinal axis of the accessory 200. The flattening 225, at its proximal end which is arranged in the conical portion 120 approximately ⅖ of the length of the conical portion 220 behind the transition to the cylindrical portion 250, forms a step 227 in the form of a planar face which is oriented perpendicularly to the longitudinal axis. The flattening 225 is continued in the same plane in the retention boss 240 as the flattening 245. This makes it possible for the flattening 225, 245 to be produced in a simple way, in that a single planar milling cut from the distal end of the accessory 200 is sufficient for this purpose.

FIG. 3 shows a side view of a third embodiment of an accessory according to the invention.

The accessory 300 is manufactured in one piece from a nickel silver alloy and comprises at the proximal end a conical portion 305 which has adjoining it in the distal direction a cylindrical main part 310. This has adjoining it, in turn, in the distal direction a conical portion 320 which a further cylindrical portion 350 and then an undercut region 330 adjoin, a cylindrical retention boss 340 adjoining the latter in turn.

In the conical portion 305, in the main part 310 and in a rear region of the conical portion 320, an orifice 315 running longitudinally is formed. This issues into the rear end face 311 of the main part 310, and its geometry corresponds to that of an implant to be simulated. Since the geometry can basically correspond to any known implant system, it is illustrated merely diagrammatically in the figure.

The main part 310, the cylindrical portion 350, the undercut region 330 and the retention boss 340 are essentially circular-cylindrical, in the cross section illustrated the conical portion 320 merging smoothly into the cylindrical portion 320, and a diameter of the retention boss 340 corresponding to the diameter of the cylindrical portion 320. The diameter of the main part 310 amounts to 6.5 mm in the example illustrated. The diameters of the main part 310, of the cylindrical portion 350 and of the retention boss 340 are in a ratio of approximately 9:6:2. The length of the accessory 300 amounts to 15 mm (proximal conical portion 305: 0.8 mm, main part: 3.4 mm, conical portion: 7.8 mm, cylindrical portion: 0.5 mm, undercut region: 1.0 mm, retention boss: 1.5 mm). The cone angle of the conical portion 320 therefore amounts to approximately 8°.

In the conical portion 320 and in the cylindrical portion 350 a flattening 325 is formed. This forms a planar face which runs parallel to the longitudinal axis of the accessory 300. The flattening 325, at its proximal end which is arranged in the conical portion 320 just half the length of the conical portion 320 behind the transition to the cylindrical portion 350, forms a step 327 in the form of a planar face which is oriented perpendicularly to the longitudinal axis. The flattening 325 is continued in the same plane in the retention boss 340 as the flattening 345. This makes it possible for the flattening 325, 345 to be produced in a simple way in that a single planar milling cut from the distal end of the accessory 300 is sufficient.

The invention is not restricted to the exemplary embodiments illustrated. The material, dimensions and also geometry of the accessory may be selected differently, in particular more or fewer portions adjoining one another may be present or other dimensional ratios may be selected. In particular, the flattening does not have to extend into the retention boss, nor does it have to extend as far as the front end of the portion proximally adjoining the undercut region.

In summary, it can be established that the invention provides an accessory which allows the accurate and simple production of dental implant-carried dentures.

1. An accessory for the production of dental implant-carried dentures in the dental technician's laboratory, the accessory having an essentially smooth outer face and a connection geometry (115; 215; 315), corresponding to a dental implant, for dentures, the accessory comprising a retention boss (140; 240; 340) which is arranged distally on the accessory (100; 200; 300), an undercut region (130; 230; 330) being formed between a base portion (120; 220; 320) of the accessory and the retention boss (140; 240; 340).

2. The accessory as recited in claim 1, whereas the outer face has a conical portion (120; 220; 320).

3. The accessory as recited in claim 2, whereas the conical portion (120; 220; 320) has a cone angle of 410°, in particular 5-8°.

4. The accessory as recited in claim 2, whereas the outer face comprises a cylindrical portion (110; 210; 310) proximally adjoining the conical portion (120; 220; 320).

5. The accessory as recited in claim 1, whereas the outer face has a flattening for securing the accessory against twisting.

6. The accessory as recited in claim 1, whereas the outer face has a step for the axial positioning of the accessory.

7. The accessory as recited in claim 1, whereas an outer cross section of the accessory remains constant or decreases from a proximal end of the accessory (100; 200; 300) as far as the undercut region.

8. The accessory as recited in claim 1, whereas the undercut region forms a parting point for the removal of the retention boss.

9. The accessory as recited in claim 1, whereas the retention boss has an essentially cylindrical form.

10. A method for the production of dental implant-carried dentures, which comprises the following steps:
a) production of a model of an affected jaw or jaw region;
b) insertion of a dental accessory into the model, a position and orientation of the accessory corresponding to a position and orientation of a dental implant to be inserted, the accessory having an essentially smooth outer face and a connection geometry (115; 215; 315), corresponding to a dental implant, for the dentures and being held in the receptacle so as to fit.

11. The method as recited in claim 10, a receptacle for the accessory being provided before the accessory is inserted in the model, a geometry of the receptacle being adapted to the position and orientation of the dental implant to be inserted.

12. The method as recited in claim 11, whereas the production of the model and the production of the receptacle are carried out by means of CAD/CAM methods, in particular in one operation.

13. The method as recited in claim 10, whereas the receptacle is provided by the insertion or casting of a cuff adapted to the accessory.

14. The method as recited in claim 10, whereas the dental accessory is cast into the model, and in that the dental accessory is subsequently drawn out of the model in the proximal direction.

15. The method as recited in claim 10, whereas the dental accessory comprises a retention boss which is arranged distally on the accessory, an undercut region being formed between a base portion and the retention boss, the retention boss being removed from the accessory, starting from a distal side of the model, before the dental accessory is drawn out.

16. The accessory as recited in claim 3, whereas the outer face comprises a cylindrical portion proximally adjoining the conical portion.
